(19) United States
(12) Patent Application Publication
(10) Pub. No.: US 2012/0137236 A1
(43) Pub. Date: May 31, 2012

(54) ELECTRONIC DEVICE

(75) Inventors: Mitsuo Abe, Osaka (JP); Masanori Kouyama, Osaka (JP); Aya Yoshizaki, Osaka (JP); Eiichiro Naito, Hyogo (JP); Yoko Akiba, Osaka (JP); Kyosuke Osuka, Osaka (JP); Eigo Tokioka, Hyogo (JP)

(73) Assignee: Panasonic Corporation, Osaka (JP)

(21) Appl. No.: 13/089,315

(22) Filed: Apr. 19, 2011

(30) Foreign Application Priority Data
Nov. 25, 2010 (JP) 2010-262155
Dec. 29, 2010 (JP) 2010-294532

(51) Int. Cl. G06F 3/048

(52) U.S. Cl. 715/763

(57) ABSTRACT

An electronic device disclosed herein includes a display unit and an operation unit. The display unit is configured to display a customized screen. The customized screen is configured to display a settings item area and a customized item area. The setting item area is configured to include a plurality of objects that corresponds to a plurality of settings items. The customized item area is configured to include one or more objects that correspond to one or more customized items selected by a user from among the plurality of settings items. The operation unit is configured to receive a customization operation from the user in which an object is selected from among the plurality of objects disposed in the settings item area and moved to the customized item area while the customized screen is being displayed in the display unit.

### CROSS-REFERENCE TO RELATED APPLICATIONS

This application claims priority under 35 U.S.C. §119 to Japanese Patent Application No. 2010-262155, filed on Nov. 25, 2010 and Japanese Patent Application No. 2010-294532, filed on Dec. 29, 2010. The entire disclosure of Japanese Patent Application No. 2010-262155 and No. 2010-294532 are hereby incorporated herein by reference.

### BACKGROUND

1. Technical Field

The technique disclosed here relates to an electronic device having multiple settings items.

2. Background Information

JP-H9-305360A, also referred to as Patent Document 1, discloses a television system. With this television system, a user can select desired settings items from multiple settings items included in a settings menu, and can create a customized settings menu made up of the selected settings items.

However, with the technique disclosed in Patent Document 1, there is a problem in that the operations for selecting the desired settings items from the multiple settings items included in the settings menu in order to create the customized settings menu are complicated for the user.

### SUMMARY

One object of the technique disclosed herein is to provide an electronic device that enables user-friendly operations for selecting one or more customized items from among multiple settings items.

In accordance with one aspect of the technology disclosed herein, an electronic device includes a display unit and an operation unit. The display unit is configured to display a customized screen. The customized screen is configured to display a settings item area and a customized item area. The setting item area is configured to include a plurality of objects that corresponds to a plurality of settings items. The customized item area is configured to include one or more objects that correspond to one or more customized items selected by a user from among the plurality of settings items. The operation unit is configured to receive a customization operation from the user in which an object is selected from among the plurality of objects disposed in the settings item area and moved to the customized item area while the customized screen is being displayed in the display unit.

These and other objects, features, aspects and advantages of the technology disclosed herein will become apparent to those skilled in the art from the following detailed description, which, taken in conjunction with the annexed drawings, discloses embodiments of the present invention.

### BRIEF DESCRIPTION OF THE DRAWINGS

Referring now to the attached drawings, which form a part of this original disclosure:

FIG. 1 is a front view of a digital camera according to a first embodiment;

FIG. 2 is a back view of the digital camera according to the first embodiment;

FIG. 3 is a block diagram of the digital camera according to the first embodiment;

FIG. 4 is a diagram illustrating a settings menu screen according to the first embodiment;

FIG. 5 is a diagram illustrating a shooting standby screen according to the first embodiment;

FIG. 6A is a diagram illustrating a screen displayed immediately before a quick settings menu screen is displayed;

FIG. 6B is a diagram illustrating a quick settings menu screen for setting the image aspect ratio/recording resolution according to the first embodiment;

FIG. 7 is a diagram illustrating a quick settings menu screen for setting a moving picture shooting mode/image quality settings according to the first embodiment;

FIG. 8 is a diagram illustrating a screen prompting the selection of customized items;

FIG. 9A is a diagram illustrating a quick settings menu screen for setting white balance according to the first embodiment;

FIG. 9B is a diagram illustrating a quick settings menu screen for setting quality according to the first embodiment;

FIG. 9C is a diagram illustrating a quick settings menu screen for setting a focus mode according to the first embodiment;

FIG. 9D is a diagram illustrating a quick settings menu screen for setting flash according to the first embodiment;

FIG. 10A is a diagram illustrating a quick settings menu screen for setting aperture according to the first embodiment;

FIG. 10B is a diagram illustrating a quick settings menu screen for setting the shutter speed according to the first embodiment;

FIG. 10C is a diagram illustrating a quick settings menu screen for setting exposure correction according to the first embodiment;

FIG. 10D is a diagram illustrating a quick settings menu screen for setting auto bracket according to the first embodiment;

FIGS. 11A through 11F are diagrams illustrating the addition and deletion of customized items in a quick customize screen according to the first embodiment;

FIG. 12 is a front view of a digital camera according to a second embodiment;

FIG. 13 is a back view of the digital camera according to the second embodiment;

FIG. 14 is a block diagram of the digital camera according to the second embodiment;

FIGS. 15A through 15F are diagrams illustrating a transition from a shooting standby screen to a settings menu screen according to the second embodiment;

FIGS. 16A through 16F are diagrams illustrating the addition of a customized item in a quick customize screen according to the second embodiment;

FIGS. 17A through 17C are diagrams illustrating the deletion of a customized item in a quick customize screen according to the second embodiment;

FIGS. 18A through 18D are diagrams illustrating the changing of a current value of a customized item in a quick settings menu screen according to the second embodiment;

FIGS. 19A through 19F are diagrams illustrating a transition from a shooting standby screen to a settings menu screen according to a variation;

FIGS. 20A through 20F are diagrams illustrating the addition of a customized item in a quick customize screen according to a variation; and

FIGS. 21A through 21F are diagrams illustrating the addition of a customized item in a quick customize screen according to another variation.

### DETAILED DESCRIPTION OF THE INVENTION

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

### 1. First Embodiment

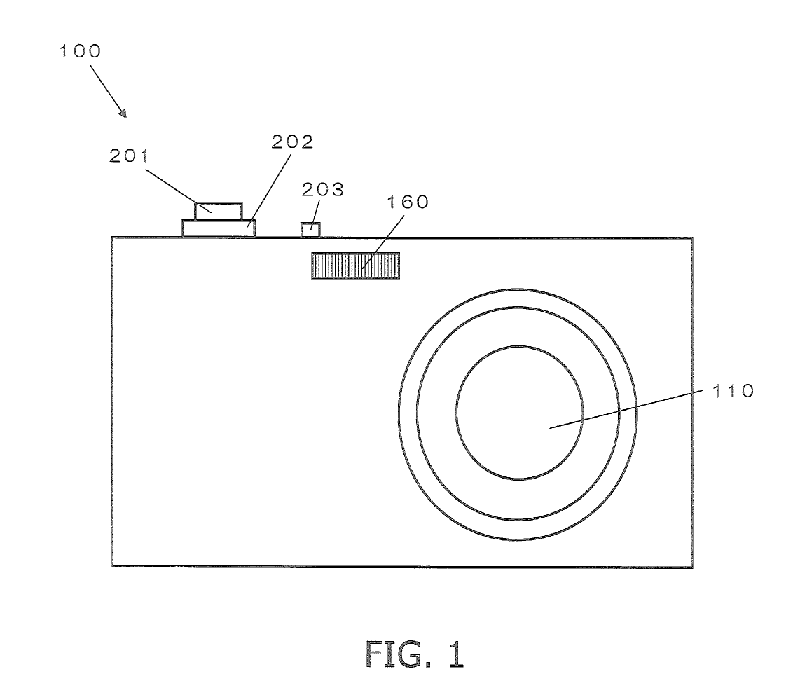

Hereinafter, a digital camera 100 (an example of an electronic device) according to a first embodiment will be described with reference to FIGS. 1 through 11. The digital camera 100 is an imaging device that captures moving pictures and still images.

(1-1. Configuration of Digital Camera)

As illustrated in FIG. 1, the digital camera 100 includes, in its front surface, a lens barrel that houses an optical system 110, and a flash 160. The digital camera 100 includes, on its top surface, elements of an operation unit 150 including a still image release button 201, a zoom lever 202, a power button 203, and so on.

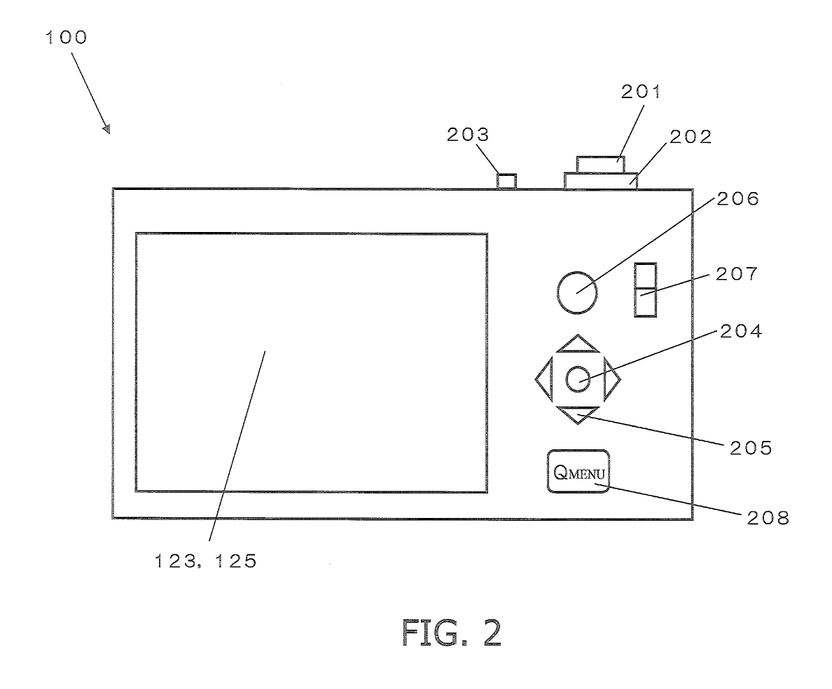

As shown in FIG. 2, the digital camera 100 includes, in its back surface, a liquid crystal monitor 123, a touch panel 125, and elements of an operation unit 150 including a center button 204, a directional button 205, a moving picture release button 206, a mode toggle switch 207, a Q menu button 208, and so on.

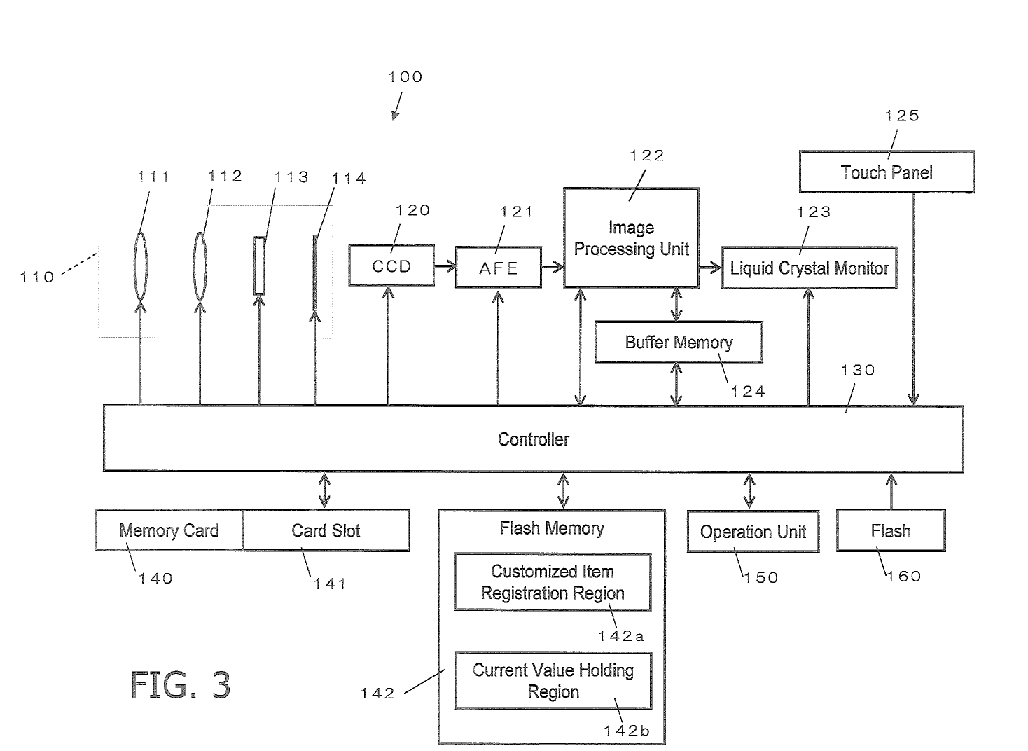

Furthermore, as shown in FIG. 3, the digital camera 100 includes the optical system 110, a CCD image sensor 120, an AFE (analog front end) 121, an image processing unit 122, a buffer memory 124, the liquid crystal monitor 123, the touch panel 125, a controller 130, a card slot 141, a memory card 140, a flash memory 142, the operation unit 150, and the flash 160.

The optical system 110 forms an image of a subject. The optical system 110 includes a focus lens 111, a zoom lens 112, an aperture 113, and a shutter 114. In another embodiment, the optical system 110 may include an OIS (Optical Image Stabilizer) lens. The lenses included in the optical system 110 may each include multiple single lenses, or may each include multiple groups of lenses.

The focus lens 111 adjusts the focus state of the subject. The zoom lens 112 adjusts the angle of view of the subject. The aperture 113 adjusts the amount of light that enters into the CCD image sensor 120. The shutter 114 adjusts the exposure time of the light that enters into the CCD image sensor 120. The focus lens 111, the zoom lens 112, the aperture 113, and the shutter 114 are each driven by driving units such as DC motors or stepping motors in accordance with control signals from the controller 130.

The CCD image sensor 120 is an imaging element that captures an image of the subject formed by the optical system 110. The CCD image sensor 120 generates image data of a frame in which the subject image is present.

The AFE (analog front end) 121 carries out various types of processes on the image data generated by the CCD image sensor 120. Specifically, the AFE 121 carries out processes such as the suppression of noise by correlated double sampling, amplification to the input range of an A/D converter by an analog gain controller, A/D conversion performed by an A/D converter, and so on.

The image processing unit 122 carries out various types of processes on the image data that has been processed by the ME 121. Specifically, the image processing unit 122 carries out processes such as smear correction, white balance correction, gamma correction, YC conversion processes, electronic zoom processes, compression processes, and so on. The image processing unit 122 is, in the present embodiment, a microcomputer that executes programs, but may be a hard-wired electronic circuit in another embodiment. The image processing unit 122 may be an integral part of the controller 130 or the like.

The controller 130 carries out the overall control of the operation of the digital camera 100 as a whole. The controller 130 includes a ROM, a CPU, and the like. In addition to programs that handle file control, auto focus control (AF control), automatic exposure control (AE control), and emission control for the flash 160, programs for carrying out the overall control of the operation of the digital camera 100 as a whole are stored in the ROM. The controller 130 stores the image data on which the various processes have been performed by the image processing unit 122 as still image data or moving picture data in the memory card 140 and the flash memory 142 (referred to hereinafter as “the memory card 140 or the like”). The controller 130 is, in the present embodiment, a microcomputer that executes programs, but may be a hard-wired electronic circuit in another embodiment. The controller 130 may be an integral part of the image processing unit 122 or the like.

The liquid crystal monitor 123 displays images such as through-the-lens images, recorded images, and so on. The through-the-lens images and recorded images are generated by the image processing unit 122. Through-the-lens images are a series of images based on a series of image data generated continuously by the CCD image sensor 120 at a set time interval while the digital camera 100 is set to a shooting mode. By referring to the through-the-lens image displayed in the liquid crystal monitor 123, a user can capture images while confirming the composition of the subject. Recorded images are images obtained by decoding (expanding) still image data or moving picture data that are recorded in the memory card 140 or the like. The recorded images are displayed in the liquid crystal monitor 123 when the digital camera 100 is set to a reproduction mode. In another embodiment, any display capable of displaying images, such as an organic EL display, a plasma display, or the like, can be used instead of the liquid crystal monitor 123.

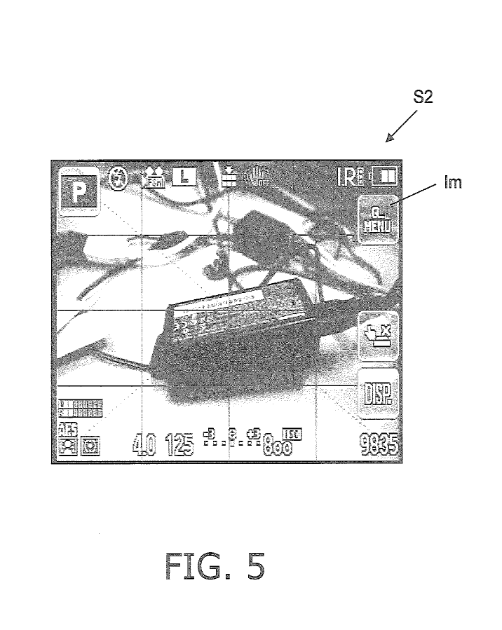

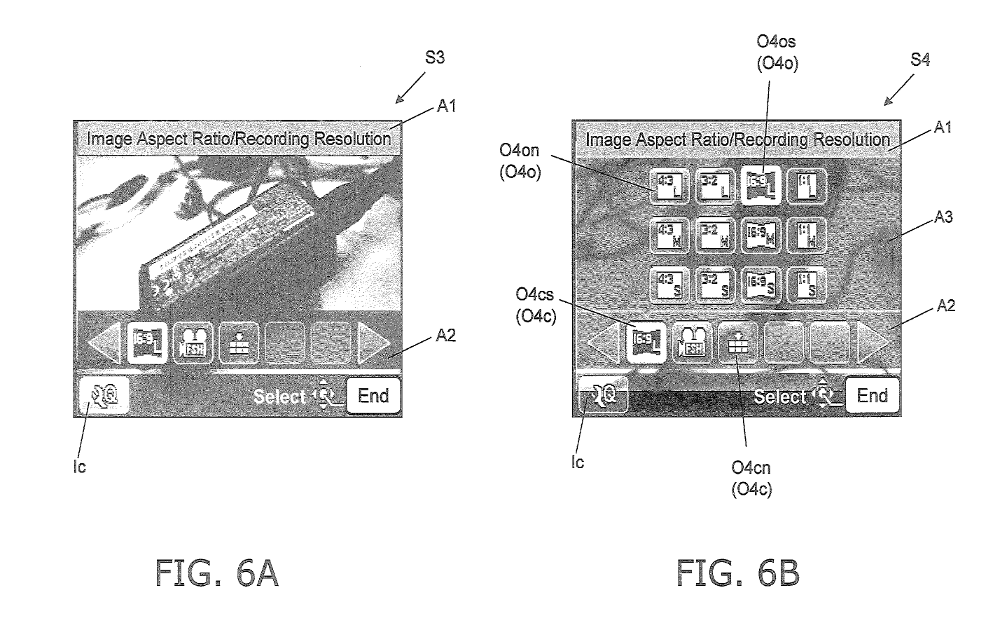

The touch panel 125 is an operation interface that receives operations from the user by working in tandem with the liquid crystal monitor 123. The touch panel 125 is disposed upon the liquid crystal monitor 123 so as to overlap with the liquid crystal monitor 123. The controller 130 detects the coordinates of a region upon the touch panel 125 that has been touched by the user (called a “touched region” hereinafter). The controller 130 determines an object displayed in a region of the liquid crystal monitor 123 that corresponds to the touched region on the touch panel 125, and executes a predetermined process in accordance with that object being selected. For example, upon determining that a region on the touch panel 125 corresponding to a “Q menu” icon Im has been touched by the user while a shooting standby screen S2, shown in FIG. 5, is displayed in the liquid crystal monitor 123, the controller 130 switches the display in the liquid crystal monitor 123 to a quick settings menu screen S4, shown in FIG. 6B (mentioned later).

The buffer memory 124 is a volatile storage medium that functions as a work memory for the image processing unit 122 and the controller 130. In the present embodiment, the buffer memory 124 is a DRAM.

The flash memory 142 is an internal memory of the digital camera 100. The flash memory 142 is a non-volatile recording medium. The flash memory 142 includes a customized item registration region 142a and a current value holding region 142b. The regions 142a and 142b will be described in greater detail later.

The memory card 140 is inserted, in a removable state, into the card slot 141. The card slot 141 is electrically and mechanically connected to the memory card 140.

The memory card 140 is an external memory of the digital camera 100. The memory card 140 is a non-volatile recording medium.

The operation unit 150 is an operation interface that receives operations from a user. “Operation unit 150” is the collective name for operational buttons, operational dials, and so on located on the outside of the digital camera 100. The operation unit 150 includes the still image release button 201, the moving picture release button 206, the zoom lever 202, the power button 203, the center button 204, the directional button 205, the Q menu button 208, and the mode toggle switch 207. Upon receiving an operation from the user, the operation unit 150 immediately sends a signal indicating the content of the operation to the controller 130.

The still image release button 201 is a push-type button for specifying the timing of still image recording. The moving picture release button 206 is a push-type button for specifying the timing of starting/ending moving picture recording. The controller 130 causes the image processing unit 122 or the like to generate still image data or moving picture data based on the timing at which the release button 201 or 206 has been depressed, and stores the generated data within the memory card 140 or the like.

The zoom lever 202 is a lever for adjusting the angle of view between a wide-angle end and a telescopic end. The controller 130 drives the zoom lens 112 based on user operations performed using the zoom lever 202.

The power button 203 is a push-type button for switching the power supply to the respective units of the digital camera 100 between on and off.

The center button 204 and the directional button 205 are push-type buttons. By manipulating the center button 204 and the directional button 205, the user can display various settings screens (including a settings menu screen S1 and the quick settings menu screen S4, described later) in the liquid crystal monitor 123, and can set values for settings items regarding various shooting conditions and reproducing conditions in the settings screens.

The Q menu button 208 is a button for transitioning to the quick settings menu screen S4. When the Q menu button 208 has been pressed by the user, the controller 130 displays the quick settings menu screen S4 in the liquid crystal monitor 123.

The mode toggle switch 207 is a push-type button for switching the digital camera 100 between the shooting mode and the reproduction mode.

(1-2. Settings Menu Screen)

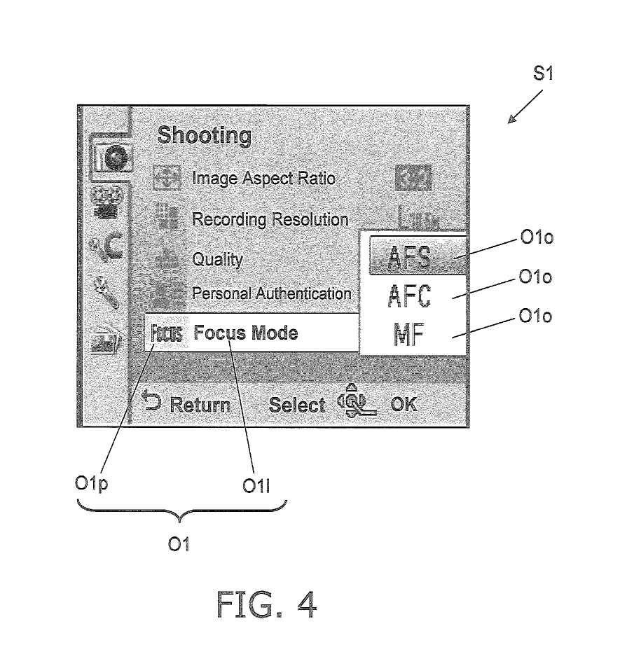

When the user carries out a predetermined operation through the operation unit 150 and/or the touch panel 125, the settings menu screen S1 illustrated in FIG. 4 (an example of a settings screen) is displayed in the liquid crystal monitor 123. The “predetermined operation” referred to here is, for example, an operation in which the center button 204 is depressed when the shooting standby screen S2 illustrated in FIG. 5 is displayed in the liquid crystal monitor 123. However, the settings menu screen S1 can be transitioned to through another operation carried out through the operation unit 150 and/or the touch panel 125.

The settings menu screen S1 is a screen for receiving a setting for a current value of each of multiple settings items related to the shooting conditions of the digital camera 100. The settings items related to the shooting conditions in the present embodiment include “image aspect ratio”, “recording resolution”, “quality”, “personal authentication”, “focus mode”, “moving picture shooting mode/image quality settings”, “white balance”, “flash”, “aperture”, “shutter speed”, “exposure correction”, “auto bracket”, and so on. However, in another embodiment, the settings items are not limited to those mentioned here.

The settings menu screen S1 shown in FIG. 4 is a screen that displays a list of multiple objects O1 that correspond to respective multiple settings items related to the shooting conditions of the digital camera 100. Each of the objects O1 includes a text portion O1l and a graphic portion O1p. The text portion O1l of an object O1 indicates the item name of the settings item corresponding to that object O1 using text or a character(s). The graphic portion O1p of an object O1 schematically illustrates the item name or current value of the settings item corresponding to that object O1 using a graphic or the like. The controller 130 sets the graphic portion O1p of the object O1 to a shape indicating the current value of the settings item corresponding to that object O1 as necessary. The current value of a settings item is determined by referring to the current value holding region 142b. The current value holding region 142b is a storage region that holds the current values of the settings items of the digital camera 100. Accordingly, the object O1 mainly indicates the type of the settings item that corresponds to that object O1. Specifically, the object O1 corresponding to “focus mode” in the present embodiment has a graphic portion O1p containing a design with the text “FOCUS” and a text portion O1l containing the text “focus mode” arranged side-by-side.

The user can select a specific object O1 from the list of objects O1 in the settings menu screen S1 by carrying out a predetermined operation using the operation unit 150 and/or the touch panel 125. When the specific object O1 is selected in the settings menu screen S1, a list of multiple objects O1o that correspond to respective multiple candidate values for the settings item corresponding to that object O1 is displayed to the right of that object O1. The object O1o indicates the candidate value corresponding to that object O1o using text or a character(s). Specifically, the objects O1o respectively corresponding to the candidate values for the “focus mode” in the present embodiment include three objects that respectively contain texts of “AFS”, “AFC”, and “MF”.

The user can select a specific object O1o from the list of objects O1o in the settings menu screen S1 by carrying out a predetermined operation using the operation unit 150 and/or the touch panel 125. When the specific object O1o is selected, the candidate value corresponding to that object O1o is registered in the current value holding region 142b as the current value of the settings item corresponding to the currently-selected object O1.

Note that in another embodiment, the shapes of the objects O1 and the objects O1o are not limited to those described above, and can take on any desired shape. For example, the objects O1 may include only the text portion O1l or only the graphic portion O1p. The objects O1o, meanwhile, may include both text and graphics, or may be only graphics.

### (1-3. Quick Settings Menu Screen)

The digital camera 100 transitions to the shooting mode when the user makes a predetermined operation through the operation unit 150 and/or the touch panel 125. The “predetermined operation” referred to here is, for example, an operation for switching the mode toggle switch 207 to the “shooting mode” side. However, the shooting mode can be transitioned to through another operation carried out through the operation unit 150 and/or the touch panel 125. The shooting standby screen S2, illustrated in FIG. 5, is displayed in the liquid crystal monitor 123 while the digital camera 100 is set to the shooting mode. The “Q menu” icon Im is disposed in the shooting standby screen S2.

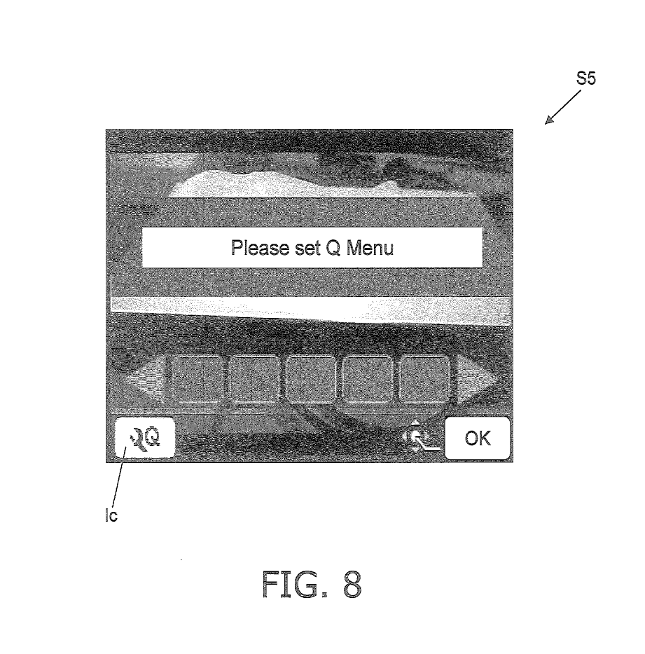

When the user selects the “Q menu” icon Im displayed in the shooting standby screen S2 by making an operation through the operation unit 150 and/or the touch panel 125, a temporary screen S3, illustrated in FIG. 6A, or an error screen S5, illustrated in FIG. 8, is displayed in the liquid crystal monitor 123. To be more specific, when the “Q menu” icon Im is selected, the controller 130 determines the number of customized items by referring to the customized item registration region 142a. In the case where it has been determined that the number of customized items is zero, the controller 130 displays the error screen S5 in the liquid crystal monitor 123. On the other hand, in the case where it has been determined that the number of customized items is one or more, the controller 130 displays the temporary screen S3 in the liquid crystal monitor 123 for a predetermined amount of time (for example, 0.3 seconds), and then displays the quick settings menu screen S4 (an example of a customized settings screen) shown in FIG. 6B.

A “customized item” is a settings item that has been selected by the user from among multiple settings items related to the shooting conditions of the digital camera 100, using a quick customize screen S6, which will be described later. The settings item selected by the user through the quick customize screen S6 is registered in the customized item registration region 142a as a customized item. The customized item registration region 142a is a region that stores information specifying zero or one or more customized items. In the present embodiment, there is no upper limit value for the number of customized items. However, in another embodiment, a predetermined upper limit value, which is one or more, may be set for the number of customized items.

The quick settings menu screen S4 is a screen for receiving current value settings for only the customized items from among the multiple settings items related to the shooting conditions of the digital camera 100. The quick settings menu screen S4 simultaneously displays an item name area A1, a customized item list area A2, and a candidate value list area A3.

The customized item list area A2 is an area that displays a list of one or more objects O4c that respectively correspond to all of the one or more customized items. There is a limit on the number of objects O4c that can be simultaneously displayed in the customized item list area A2 (a maximum of five, in the present embodiment). Accordingly, as shown in FIG. 6B, arrow-shaped objects pointing to the left and right are disposed in the customized item list area A2. By selecting the arrow-shaped objects through the operation unit 150 and/or the touch panel 125, the user can cause the row of objects O4c within the customized item list area A2 to scroll to the left and right. As a result, the user can display the objects O4c corresponding to all the customized items within the customized item list area A2.

Each object O4c is an icon that schematically illustrates the type or current value of the customized item that corresponds to that object O4c, using graphics or the like. Accordingly, the user can instinctively understand the type or current value of a customized item corresponding to an object O4c simply by glancing at that object O4c. Whether an object O4c indicates the type of the customized item or the current value of the customized item depends on the type of the customized item to which that object O4c corresponds. For example, the object O4c farthest to the left in FIG. 6B indicates the current value for the “image aspect ratio/recording resolution”, which is “16:9/L”.

As described thus far, a list of objects O4c indicating the current values of the customized items can be displayed in the customized item list area A2. Accordingly, the customized item list area A2 can also function as an area for displaying a list of the current values of the customized items.

By performing a predetermined operation through the operation unit 150 and/or the touch panel 125, the user can select a specific object O4c from among the one or more objects O4c in the customized item list area A2. The currently-selected object O4c (called a “selected object O4cs” hereinafter) and the other objects O4c (called “non-selected objects O4cn” hereinafter) are displayed in the customized item list area A2 using different color tones. In the present embodiment, the selected object O4cs has a opaque color tone using a color combination (for example, yellow and black) whereas the non-selected objects O4cn have another color tone using another color combination (for example, white and black) with a higher level of transparency, so that the background can be seen therethrough.

The item name area A1 is an area in which the item name of the customized item corresponding to the selected object O4cs is indicated using text or a character(s). Accordingly, the item name area A1 indicates the type of the customized item corresponding to the selected object O4cs.

The candidate value list area A3 is an area that displays a list of multiple objects O4o that respectively correspond to multiple candidate values for the customized item that corresponds to the selected object O4cs. Each object O4o is an icon that schematically illustrates the candidate value that corresponds to that object O4o, using graphics or the like. Accordingly, the user can instinctively understand the candidate value corresponding to an object O4o simply by glancing at that object O4o.

A single object O4o is selected in the candidate value list area A3. The currently-selected object O4o (called a “selected object O4os” hereinafter) and the other objects O4o (called “non-selected objects O4 on” hereinafter) are displayed in the candidate value list area A3 using different color tones. In the present embodiment, the selected object O4os has a opaque color tone using a color combination (for example, yellow and black) whereas the non-selected objects O4 on have another color tone using another color combination (for example, white and black) with a higher level of transparency, so that the background can be seen therethrough. Immediately after transitioning from the temporary screen S3 to the quick settings menu screen S4, the selected object O4os indicates the current value of the customized item corresponding to the selected object O4cs.

The user can select one of the non-selected objects O4 on in the candidate value list area A3 by carrying out a predetermined operation using the operation unit 150 and/or the touch panel 125. When one of the non-selected objects O4 on is selected by the user, the selected non-selected object O4 on is switched with the selected object O4os. As a result, the current value of the customized item that corresponds to the selected object O4cs is changed to the candidate value that corresponds to the new selected object O4os. The controller 130 registers the changed current value of the customized item corresponding to the selected object O4cs in the current value holding region 142b.

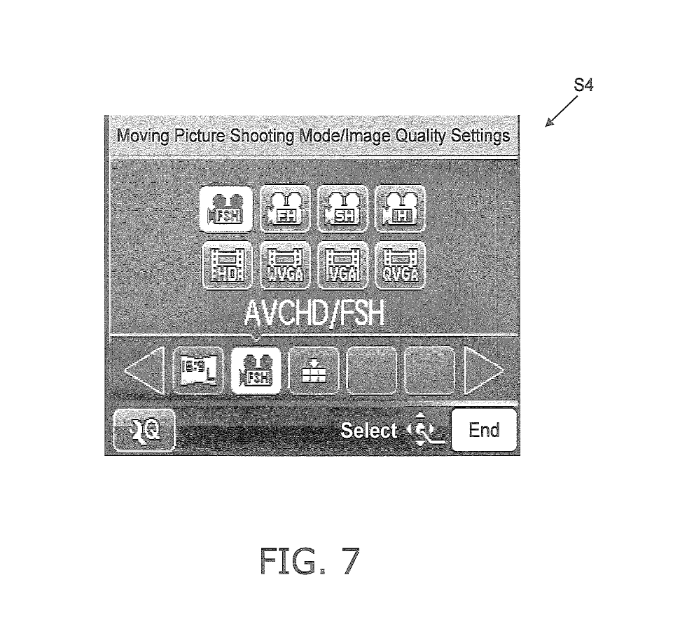

Meanwhile, by performing a predetermined operation through the operation unit 150 and/or the touch panel 125, the user can select one of the non-selected objects O4cn in the customized item list area A2. When one of the non-selected objects O4cn is selected by the user, the selected non-selected object O4cn is switched with the selected object O4cs. As a result, a list of the candidate values for the customized item corresponding to the new selected object O4cs is displayed in the candidate value list area A3. For example, when the non-selected object O4cn that corresponds to “moving picture shooting mode/image quality settings” in the quick settings menu screen S4 illustrated in FIG. 6B is selected, the screen transitions to the quick settings menu screen S4 illustrated in FIG. 7.

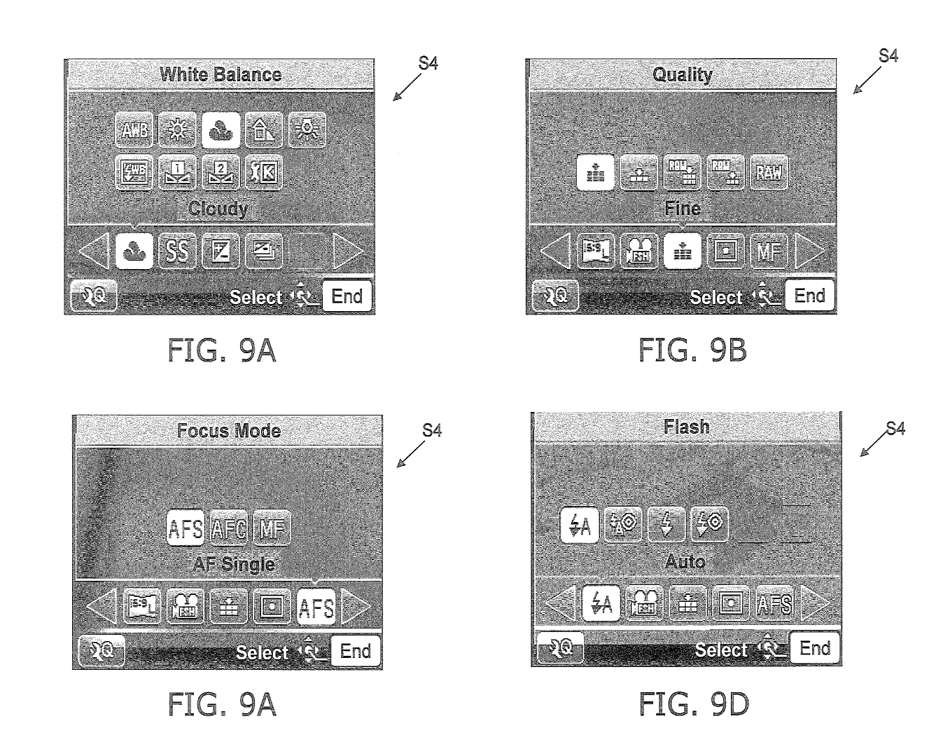

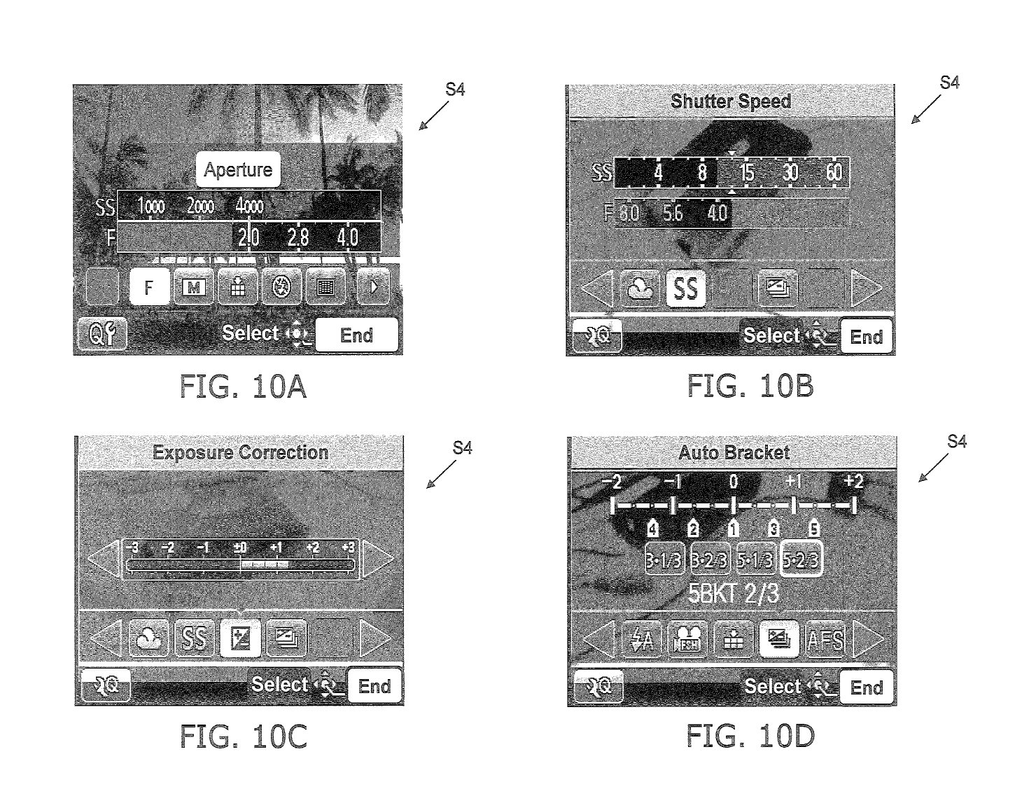

As described above, the objects O4c include both objects that indicate the type of the customized item and objects that indicate the current value of the customized item. The quick settings menu screens S4 illustrated in FIGS. 9A through 9D are examples indicating the case where the selected object O4cs indicates the current value of the customized item. The quick settings menu screens S4 illustrated in FIGS. 10A through 10D, meanwhile, are examples indicating the case where the selected object O4cs indicates the type of the customized item. The values of settings items such as “aperture”, “shutter speed”, and “exposure correction” in FIGS. 10A through 10C are changed either in an analog form or digitally in small increments. Accordingly, this type of settings item is not suited for displaying a list of all candidate value objects O4o in the candidate value list area A3, as in the examples shown in FIGS. 6B, 7, and 9A through 9D. Therefore, instead of a list of candidate value objects O4o, a meter is displayed in the candidate value list area A3 for settings items of this type. By moving a bar of the meters through the operation unit 150 and/or the touch panel 125, the user can change the current values of the settings items either in an analog form or digitally in small increments. Note that in the “auto bracket” example in FIG. 10D, a meter is displayed in the candidate value list area A3 in addition to the candidate value objects O4o. In the present embodiment, the “auto bracket” meter is inactive. To rephrase, the “auto bracket” meter displays the candidate values for “auto bracket” in a way in which the user can instinctively understand those values. In other words, the user cannot move the bar of the meter through the operation unit 150 and/or the touch panel 125. However, in another embodiment, the “auto bracket” meter may be active. To rephrase, it may be possible for the user to change the “auto bracket” current value either in an analog form or digitally in small increments by moving the bar of the meter through the operation unit 150 and/or the touch panel 125.

The temporary screen S3 shown in FIG. 6A is a screen in which the candidate value list area A3 has been removed from the quick settings menu screen S4 shown in FIG. 6B. The temporary screen S3 is displayed for only a short amount of time immediately before transitioning to the quick settings menu screen S4. Accordingly, the user sees the list of customized item candidate values in the candidate value list area A3 following a short delay after seeing the list of customized items in the customized item list area A2. As a result, the user can instinctively understand that the objects O4o displayed in the candidate value list area A3 are lower-level entities than the objects O4c displayed in the customized item list area A2 (that is, that the objects O4o and the objects O4c are in a dependent relationship).

A “Q customize” icon Ic is disposed in the lower-left of the temporary screen S3 and the quick settings menu screen S4. The user can select the “Q customize” icon Ic in the screens S3 and S4 by carrying out a predetermined operation through the operation unit 150 and/or the touch panel 125. When the “Q customize” icon Ic is selected, the controller 130 displays the quick customize screen S6, mentioned later, in the liquid crystal monitor 123.

The error screen S5 illustrated in FIG. 8 is, as described above, a screen that is displayed in the case where the number of customized items is zero when the “Q menu” icon Im has been selected in the shooting standby screen S2. The error screen S5 displays a message prompting the user to select a customized item. The “Q customize” icon Ic is disposed in the error screen S5. The user can select the “Q customize” icon Ic in the screen S5 by carrying out a predetermined operation through the operation unit 150 and/or the touch panel 125. When the “Q customize” icon Ic is selected, the controller 130 displays the quick customize screen S6, mentioned later, in the liquid crystal monitor 123. Accordingly, having seen the message prompting the selection of a customized item, the user can cause the quick customize screen S6 to be displayed in the liquid crystal monitor 123 immediately by selecting the “Q customize” icon Ic. The quick customize screen S6 is a screen for receiving, from the user, the selection of a customized item from among the multiple settings items related to the shooting conditions of the digital camera 100.

The quick settings menu screen S4 is generated by the controller 130. When instructed to display the screen S4, the controller 130 specifies customized items by referring to the customized item registration region 142a. Then, the controller 130 disposes the objects O4c corresponding to the specified customized items in the customized item list area A2. The controller 130 sets the shapes of the objects O4c to shapes that are based on the current values of the customized items corresponding to those objects O4c as necessary, by referring to the current value holding region 142b. At the same time, the controller 130 disposes in the candidate value list area A3 the objects O4o that respectively correspond to the candidate values of the customized item corresponding to the selected object O4cs.

(1-4. Quick Customize Screen)

As described thus far, the quick customize screen S6 (an example of a customized screen) is displayed in the liquid crystal monitor 123 as a result of the “Q customize” icon Ic being selected in the screen S3, S4, or S5. However, the quick customize screen S6 can also be displayed as a result of another operation made through the operation unit 150 and/or the touch panel 125.

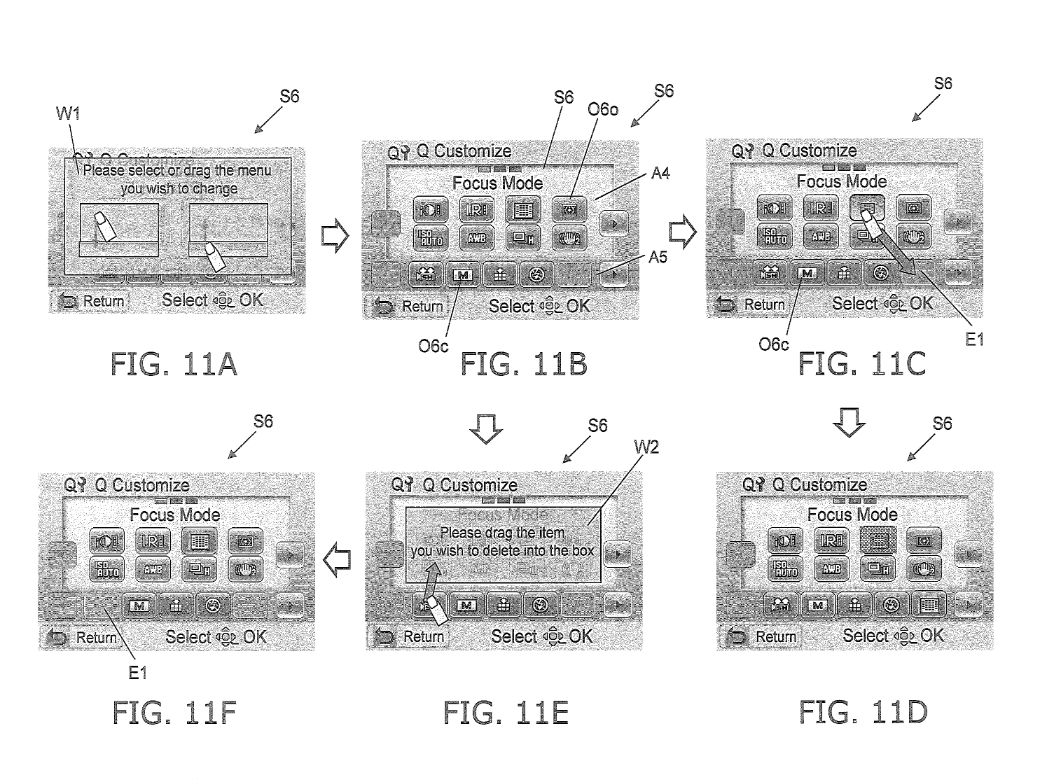

As illustrated in FIG. 11A, a message window W1 is displayed over the quick customize screen S6 for several seconds (for example, three seconds, five seconds, or the like) immediately after the quick customize screen S6 has been transitioned to; the message window W1 disappears thereafter. The message window W1 displays a message for guiding the user how to add and delete customized items. Although the message window W1 disappears automatically in the present embodiment, the message window W1 may disappear under the condition that a predetermined operation has been made in another embodiment.

As shown in FIG. 11B, the quick customize screen S6 simultaneously displays a settings item area A4 (an example of a settings item area) and a customized item area A5 (an example of a customized item area). The settings item area A4 is an area in which multiple objects O6o (examples of an object disposed in a settings item area) respectively corresponding to multiple settings items regarding the shooting conditions of the digital camera 100 can be disposed. To rephrase, the settings item area A4 is an area for displaying a list of multiple objects O6o respectively corresponding to multiple settings items regarding the shooting conditions of the digital camera 100. The customized item area A5 is an area in which one or more objects O6c (examples of an object disposed in a customized item area) respectively corresponding to one or more customized items selected by the user from among the multiple settings items related to the shooting conditions of the digital camera 100 can be disposed. To rephrase, the customized item area A5 is an area that displays a list of one or more objects O6c that respectively correspond to one or more customized items.

As shown in FIGS. 11C through 11F, in the case where the user wishes to add or delete a customized item, the user customizes the customized item area A5 by carrying out a customization operation through the touch panel 125.

To be more specific, the customization operation in the case where a customized item is to be added is an operation in which an object O6o, disposed in the settings item area A4 and corresponding to the settings item that is to be added as a customized item, is dragged and dropped to an empty region E1 in the customized item area A5 (see FIGS. 11C and 11D). The empty region E1 is a region within the customized item area A5 in which an object O6c is not disposed, and is a region that has approximately the same size as the objects O6o and 06c. The objects O6o and the objects O6c have approximately the same size. The controller 130 stores information specifying the settings item corresponding to the object O6o moved from the settings item area A4 to the customized item area A5 through the customization operation in the customized item registration region 142a as information specifying the customized item.

The objects O6o corresponding to the settings items that have already been registered as customized items are displayed in a grayed-out state within the settings item area A4, so that the user cannot select those objects (see FIG. 11D).

Meanwhile, the customization operation in the case where a customized item is to be deleted is an operation in which an object O6c, disposed in the customized item area A5 and corresponding to the customized item that is to be deleted, is dragged and dropped to an area in the settings item area A4 (see FIGS. 11E and 11F). When an object O6c in the customized item area A5 is selected, a message window W2 guiding the user to the drop destination is displayed over the settings item area A4. The user is thus not uncertain as to where the dragged object O6c is to be moved to. The controller 130 deletes, from the customized item registration region 142a, the information specifying the customized item corresponding to the object O6c that was moved from the customized item area A5 to the settings item area A4 through the customization operation.

The region in the customized item area A5 in which the object O6c corresponding to the deleted customized item was disposed then becomes an empty region E1 (see FIG. 11F). Furthermore, in the settings item area A4, the grayed-out display of the object O6o corresponding to the customized item (settings item) that was deleted is canceled.

Note that the customization operation can also be carried out through the operation unit 150. Accordingly, the user can select the object O6o or 06c disposed in the settings item area A4 or the customized item area A5 and move that object into the customized item area A5 or the settings item area A4 not only in the case where a predetermined operation is made through the touch panel 125, but also in the case where a predetermined operation is made through the operation unit 150.

In the present embodiment, there is no upper limit value for the number of customized items. There is, however, a limit on the number of objects O6c that can be simultaneously displayed in the customized item area A5 (a maximum of five, in the present embodiment). Accordingly, as shown in FIG. 11, arrow-shaped objects pointing to the left and right are disposed in the customized item area A5. By selecting the arrow-shaped objects through the operation unit 150 and/or the touch panel 125, the user can cause the row of objects O6c within the customized item area A5 to scroll to the left and right. As a result, the user can display the objects O6c corresponding to all the customized items within the customized item area A5.

There is also a limit on the number of objects O6o that can be simultaneously displayed in the settings item area A4 (a maximum of eight, in the present embodiment). Accordingly, as shown in FIG. 11, arrow-shaped objects pointing to the left and right are disposed in the settings item area A4. By selecting the arrow-shaped objects through the operation unit 150 and/or the touch panel 125, the user can cause the row of objects O6o within the settings item area A4 to scroll to the left and right. As a result, the user can display the objects O6o respectively corresponding to all of the settings items regarding the shooting conditions of the digital camera 100 in the settings item area A4.

The objects O6c and 06o are icons that schematically illustrate the types or the current values of the settings items that correspond to those objects O6c and 06o, using graphics or the like. Accordingly, the user can instinctively understand the types or current values of the settings items corresponding to the objects O6c and 06o simply by glancing at the objects O6c and 06o. Whether the objects O6c and 06o indicate the type of the settings items or the current value of the settings items depends on the type of the settings items to which those objects O6c and 06o correspond. The objects O6c and 06o have the same appearance as the object O4c that corresponds to the same settings item. Accordingly, an object O6o having an appearance that indicates the current value of the settings item and an object O6o having an appearance that indicates the type of the settings item are disposed in the settings item area A4. In addition, in accordance with the type of customized item that is registered, an object O6c having an appearance that indicates the current value of the customized item and/or an object O6c having an appearance that indicates the type of the customized item are disposed in the customized item area A5.

As described thus far, a list of objects O6c indicating the current values of the customized items can be displayed in the customized item area A5. Accordingly, the customized item area A5 can also function as an area for displaying a list of the current values of the customized items.

The quick customize screen S6 is generated by the controller 130. When instructed to display the screen S6, the controller 130 specifies customized items by referring to the customized item registration region 142a. Then, the controller 130 disposes the objects O6c corresponding to the specified customized items in the customized item area A5. The controller 130 sets the shapes of the objects O6c to shapes that are based on the current values of the customized items corresponding to those objects O6c as necessary, by referring to the current value holding region 142b. At the same time, the controller 130 disposes the objects O6o corresponding to the settings items that were not specified as customized items in the settings item area A4. The controller 130 sets the shapes of the objects O6o to shapes that are based on the current values of the settings items corresponding to those objects O6o as necessary, by referring to the current value holding region 142b.

### 2. Second Embodiment

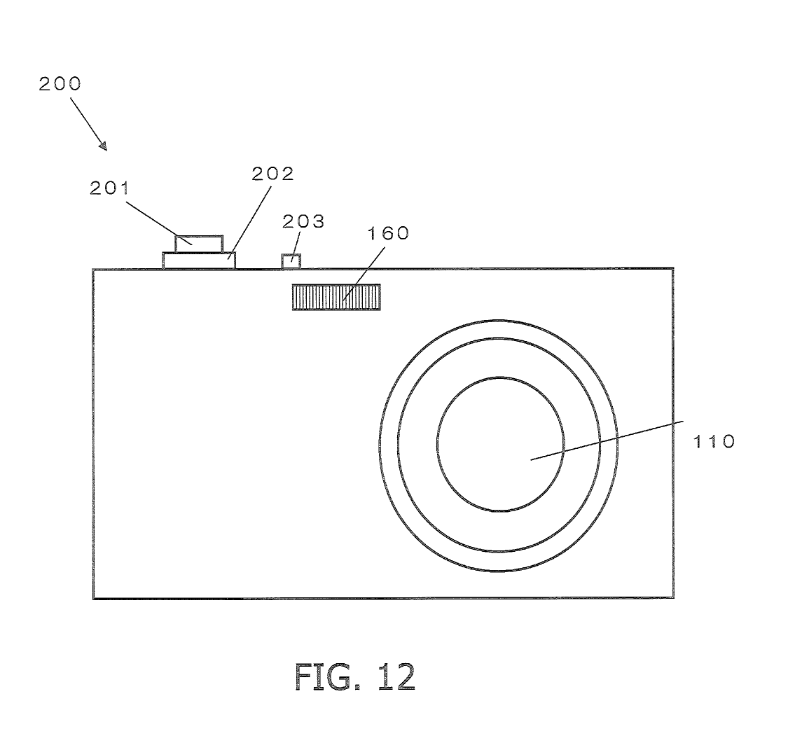

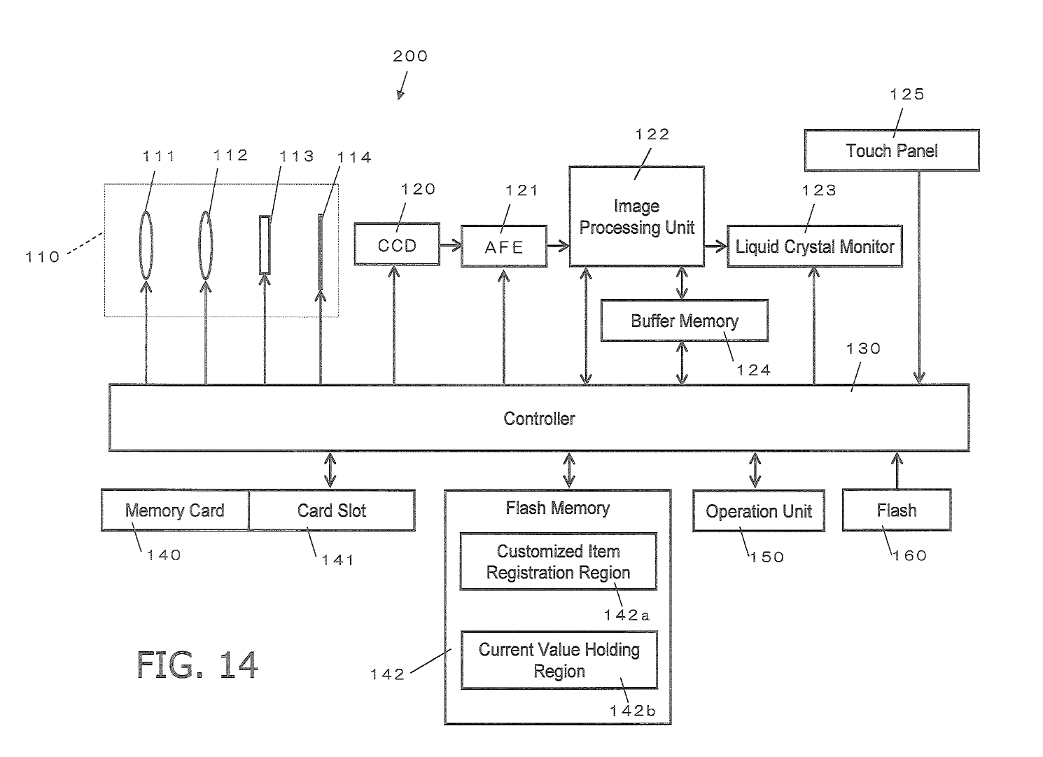

Hereinafter, a digital camera 200 (an example of an electronic device) according to a second embodiment will be described with reference to FIGS. 12 through 18. Here, the digital camera 200 will be described focusing on the differences between the digital camera 200 and the digital camera 100 according to the first embodiment. Elements found in both the first and second embodiments will be assigned the same reference numerals, and descriptions thereof will be omitted.

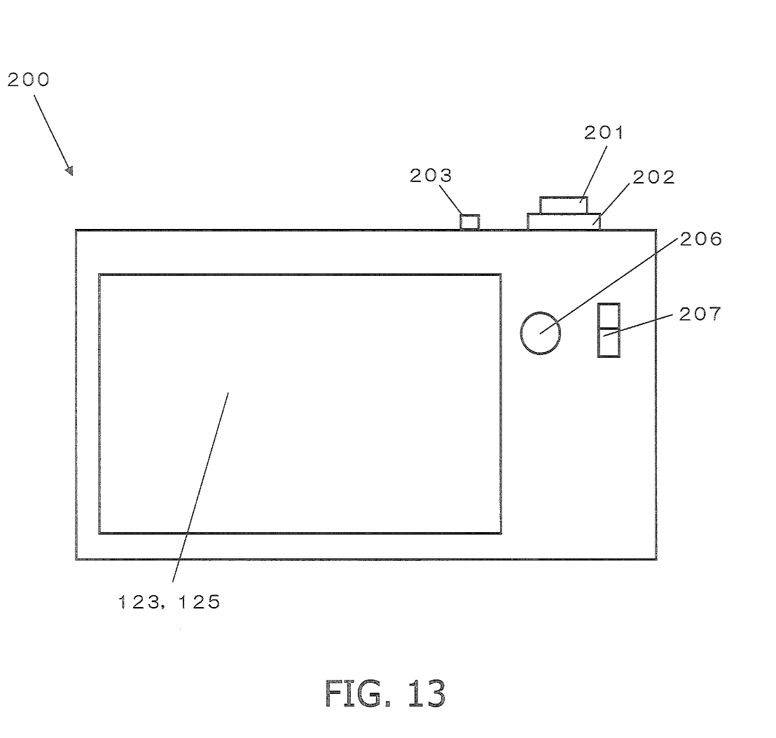

As shown in FIG. 13, compared to the digital camera 100, the center button 204, the directional button 205, and the Q menu button 208 have been omitted from the digital camera 200. Furthermore, compared to the digital camera 100, with the digital camera 200, a shooting standby screen S11 having a similar function as the shooting standby screen S2 is displayed instead of the shooting standby screen S2; a settings menu screen S13 having a similar function as the settings menu screen S1 is displayed instead of the settings menu screen S1; a quick settings menu screen S15 having a similar function as the quick settings menu screen S4 is displayed instead of the quick settings menu screen S4; and a quick customize screen S14 having a similar function as the quick customize screen S6 is displayed instead of the quick customize screen S6.

(2-1. Settings Menu Screen)

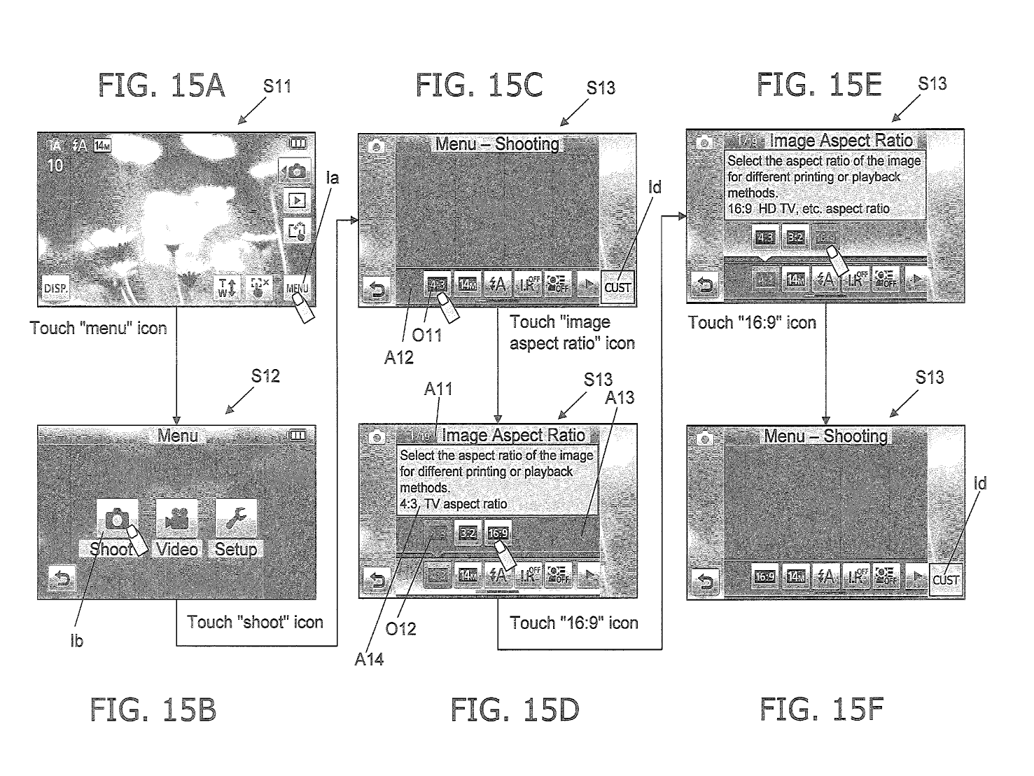

The digital camera 200 transitions to the shooting mode when the user makes a predetermined operation through the touch panel 125. The shooting standby screen S11, illustrated in FIG. 15A, is displayed in the liquid crystal monitor 123 while the digital camera 200 is set to the shooting mode. A “menu” icon Ia is disposed in the shooting standby screen S11. When the user selects the “menu” icon Ia through the touch panel 125, the digital camera 200 transitions to the screen S12 illustrated in FIG. 15B. Then, when the user selects a “shooting” icon 1b in the screen S12 through the touch panel 125, the digital camera 200 transitions to the settings menu screen S13 (an example of a settings screen) illustrated in FIG. 15C.

The settings menu screen S13 is a screen for receiving current value settings for each of multiple settings items related to the shooting conditions of the digital camera 200. The settings menu screen S13 displays an item name area A11, a settings item list area A12, a candidate value list area A13, and a message area A14.

The settings item list area A12 is an area for displaying a list of multiple objects O11 respectively corresponding to multiple settings items regarding the shooting conditions of the digital camera 200. Each object O11 is an icon that schematically illustrates the type or the current value of the settings item that corresponds to that object O11, using graphics or the like. The controller 130 sets the objects O11 to shapes that indicate the types or the current values of the settings items that correspond to those objects O11.

As shown in FIGS. 15C and 15D, when the user selects a specific object O11 in the settings item list area A12 through the touch panel 125, the candidate value list area A13 and the message area A14 are displayed. A list of multiple objects O12 respectively corresponding to multiple candidate values for the settings item that corresponds to the currently-selected object O11 is displayed in the candidate value list area A13. The object O12 corresponding to the current value is displayed in the candidate value list area A13 using a different color tone than the other objects O12. The message area A14 displays a description of the settings item corresponding to the currently-selected object O11 and the candidate value corresponding to the currently-selected object O12.

As shown in FIGS. 15D and 15E, when the user selects an object O12 aside from the object O12 corresponding to the current value in the candidate value list area A13 through the touch panel 125, the description displayed in the message area A14 is changed so as to correspond to the candidate value corresponding to the selected object O12. When the user then once again selects the same object O12 through the touch panel 125, the candidate value corresponding to the selected object O12 becomes the current value of the settings item corresponding to the currently-selected object O11. The controller 130 registers the changed current value of the settings item corresponding to the currently-selected object O11 in the current value holding region 142b. At the same time, as shown in FIG. 15F, the candidate value list area A13 and the message area A14 disappear from the settings menu screen S13.

As described thus far, in the present embodiment, when an object O12 within the candidate value list area A13 is pressed twice, the current value changes to the candidate value corresponding to that object O12. However, the operations for changing the current value are not limited to the aforementioned operations. For example, a description of the candidate value corresponding to an object O12 in the candidate value list area A13 may be displayed in the message area A14 while that object O12 is being pressed by the user through the touch panel 125, and the current value may then be changed to the candidate value corresponding to that object O12 when the user releases pressure from the object O12. Furthermore, in this variation, in the case where the user has pressed a certain object O12 (called a “temporarily-selected object O12” hereinafter) and then slides his or her finger to an adjacent object O12 so as to select that adjacent object O12, a description of the candidate value corresponding to the adjacent object O12 that is being pressed may be displayed in the message area A14, and the current value may then be changed to the candidate value corresponding to the adjacent object O12 when the pressure on the adjacent object O12 is released.

(2-2. Quick Customize Screen)

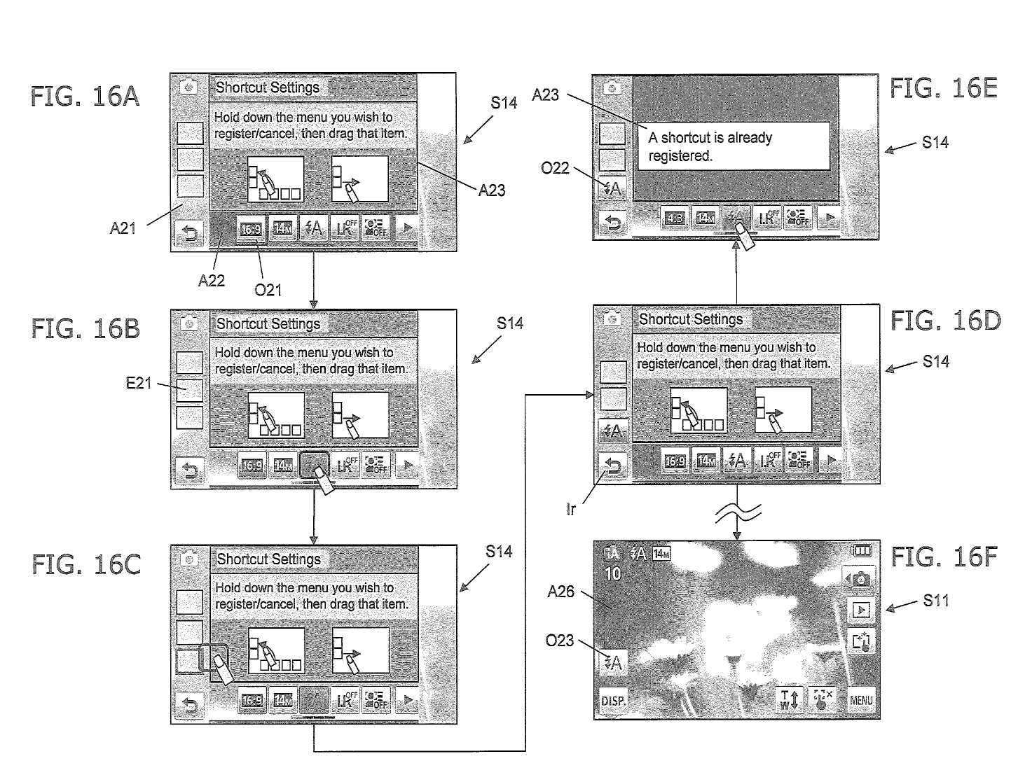

A “customize” icon Id is disposed in the settings menu screen S13. When the user selects the “customize” icon Id in the settings menu screen S13 through the touch panel 125, the digital camera 200 transitions to the quick customize screen S14 (an example of a customized screen) illustrated in FIG. 16A. The quick customize screen S14 is a screen for receiving, from the user, the selection of a customized item from among the multiple settings items related to the shooting conditions of the digital camera 200.

As shown in FIG. 16, the quick customize screen S14 simultaneously displays a settings item area A22 (an example of a settings item area), a customized item area A21 (an example of a customized item area), and a message area A23. The settings item area A22 is an area in which multiple objects O21 (examples of an object disposed in a settings item area) respectively corresponding to multiple settings items regarding the shooting conditions of the digital camera 200 can be disposed. To rephrase, the settings item area A22 is an area for displaying a list of multiple objects O21 respectively corresponding to multiple settings items regarding the shooting conditions of the digital camera 200. The customized item area A21 is an area in which one or more objects O22 (examples of an object disposed in a customized item area) respectively corresponding to one or more customized items selected by the user from among the multiple settings items related to the shooting conditions of the digital camera 200 can be disposed. To rephrase, the customized item area A21 is an area that displays a list of one or more objects O22 that respectively correspond to one or more customized items. In the present embodiment, an upper limit value (in the present embodiment, a maximum of three) is set for the number of customized items. However, it is also possible to not set an upper limit value, as in the first embodiment. The message area A23 displays a message for guiding the user how to add and delete customized items at the timings illustrated in FIGS. 16A through D.

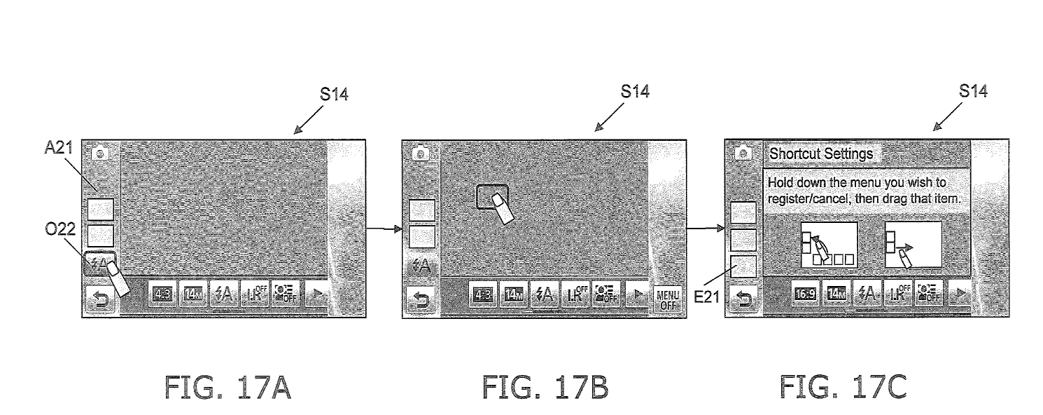

As shown in FIGS. 16B through 16D and FIG. 17, in the case where the user wishes to add or delete a customized item, the user customizes the customized item area A21 by performing a customization operation through the touch panel 125.

To be more specific, the customization operation in the case where a customized item is to be added is an operation in which an object O21, disposed in the settings item area A22 and corresponding to the settings item that is to be added as a customized item, is dragged and dropped to an empty region E21 in the customized item area A21 (see FIGS. 16B through 16D). The empty region E21 is a region within the customized item area A21 in which an object O22 is not disposed, and is a region that has approximately the same size as the objects O21 and O22. The objects O21 and the objects O22 have approximately the same size. The controller 130 stores information specifying the settings item corresponding to the object O21 moved from the settings item area A22 to the customized item area A21 through the customization operation in the customized item registration region 142a as information specifying the customized item. Note that as shown in FIGS. 16B through 16D, in the present embodiment, the object that is visually moved in the display through the drag-and-drop operation is an outer frame of the object O21.

Meanwhile, the customization operation in the case where a customized item is to be deleted is an operation in which an object O22, disposed in the customized item area A21 and corresponding to the customized item that is to be deleted, is dragged and dropped to an area outside of the customized item area A21 (see FIGS. 17A through 17C). The controller 130 deletes, from the customized item registration region 142a, the information specifying the customized item corresponding to the object O22 that was moved from the customized item area A21 to outside of the customized item area A21 through the customization operation. Note that as shown in FIG. 17, in the present embodiment, the object that is visually moved in the display through the drag-and-drop operation is an outer frame of the object O21. The region in the customized item area A21 in which the object O22 corresponding to the deleted customized item was disposed then becomes an empty region E21 (see FIG. 17C).

Accordingly, by carrying out a predetermined operation through the touch panel 125, the user can select an object O21 or 022 disposed in the settings item area A22 or the customized item area A21 and move that object to the settings item area A21 or the customized item area A22.

When the user attempts to select an object O21 in the settings item area A22 that corresponds to a settings item that has already been registered as a customized item through the touch panel 125, a predetermined message is displayed in the message area A23 (see FIG. 16E). The “predetermined message” is a message indicating that the settings item corresponding to the object O21 that the user is attempting to select is already registered as a customized item. Objects O21 corresponding to customized items cannot be selected. Note that in the settings item area A22, it is preferable to display objects O21 that cannot be selected (that is, objects O21 corresponding to settings items that have already been registered as customized items) in a different form than the other selectable objects O21, so that the objects O21 that cannot be selected can be distinguished as such (for example, a grayed-out display).

When the user selects a “return” icon Ir in the quick customize screen S14 through the touch panel 125, the digital camera 200 transitions to the settings menu screen S13. After this, when the “return” icon is selected in the settings menu screen S13, the digital camera 200 transitions to the screen S12. Then, when the “return” icon is selected in the screen S12, the digital camera 200 transitions to the shooting standby screen S11 (see FIG. 16F). The shooting standby screen S11 includes a customized item list area A26. The customized item list area A26 is an area that displays a list of all of zero to three objects O23 that respectively correspond to zero to three customized items.

The objects O21 to O23 are icons that schematically illustrate the types or the current values of the settings items that correspond to those objects O21 to O23, using graphics or the like. Accordingly, the user can instinctively understand the types or current values of the settings items corresponding to the objects O21 to O23 simply by glancing at the objects O21 to O23. Whether the objects O21 to O23 indicate the types of the settings items or the current values of the settings items depends on the type of the settings items to which those objects O21 to O23 correspond. In the example shown in FIG. 16F, the object O23 indicates a current value of “auto” for the “flash”. The objects O21 to O23 have the same appearance as the object O11 that corresponds to the same settings item. Accordingly, a list of objects O23 indicating the current values of the customized items can be displayed in the customized item list area A26. Therefore, the customized item list area A26 can also function as an area for displaying a list of the current values of the customized items.

There is also a limit on the number of objects O21 that can be simultaneously displayed in the settings item area A22 (a maximum of five, in the present embodiment). Accordingly, as shown in FIGS. 16 and 17, arrow-shaped objects are disposed in the settings item area A22. By selecting the arrow-shaped objects through the operation unit 150 and/or the touch panel 125, the user can cause the row of objects O21 within the settings item area A22 to scroll to the left and right. As a result, the user can display the objects O22 corresponding to all of the settings items regarding the shooting conditions of the digital camera 200 in the settings item area A22.

The quick customize screen S14 is generated by the controller 130. When instructed to display the screen S14, the controller 130 specifies customized items by referring to the customized item registration region 142a. Then, the controller 130 disposes the objects O22 corresponding to the specified customized items in the customized item area A21. The controller 130 sets the shapes of the objects O22 to shapes that are based on the current values of the customized items corresponding to those objects O22c as necessary, by referring to the current value holding region 142b. At the same time, the controller 130 disposes in the settings item area A22 the objects O21 corresponding to the settings items that were not specified as customized items. The controller 130 sets the shapes of the objects O21 to shapes that are based on the current values of the settings items corresponding to those objects O21 as necessary, by referring to the current value holding region 142b.

The shooting standby screen S11 is also generated by the controller 130. When instructed to display the screen S11, the controller 130 specifies customized items by referring to the customized item registration region 142a. Then, the controller 130 disposes the objects O23 corresponding to the specified customized items in the customized item list area A26. The controller 130 sets the shapes of the objects O23 to shapes that are based on the current values of the customized items corresponding to those objects O23 as necessary, by referring to the current value holding region 142b.

(2-3. Quick Settings Menu Screen)

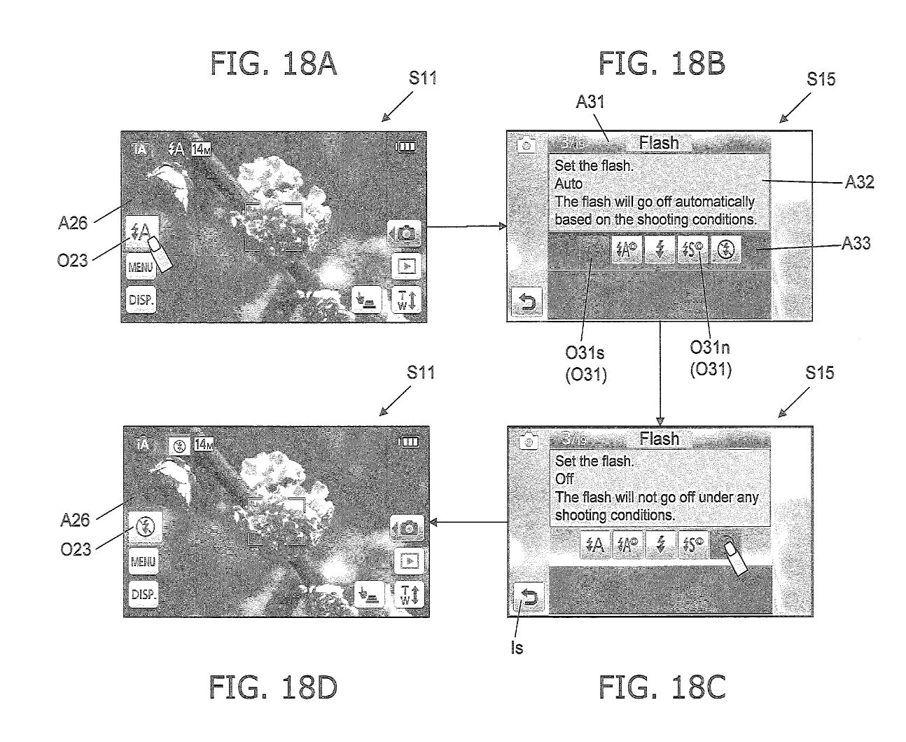

As shown in FIGS. 18A and 18B, when the user selects an object O23 within the customized item list area A26 in the shooting standby screen S11 by making a operation through the touch panel 125, the quick settings menu screen S15 (an example of a customized settings screen) is displayed in the liquid crystal monitor 123. The shooting standby screen S11 shown in FIG. 18A is an example of the case where “flash” has been registered as a customized item. Hereinafter, an object O23 involved in a selection operation that has caused the quick settings menu screen S15 to be displayed will be referred to as a “selected object O23”.

The quick settings menu screen S15 is a screen for receiving the setting of a current value of a customized item that corresponds to the selected object O23. The quick settings menu screen S15 simultaneously displays an item name area A31, a message area A32, and a candidate value list area A33.

The item name area A31 is an area in which the item name of the customized item corresponding to the selected object O23 is indicated using text. Accordingly, the item name area A31 indicates the type of the customized item corresponding to the selected object O23.

The candidate value list area A33 is an area that displays a list of multiple objects O31 that respectively correspond to multiple candidate values for the customized item that corresponds to the selected object O23. Each object O31 is an icon that schematically illustrates the candidate value that corresponds to that objects O31, using graphics or the like. Accordingly, the user can instinctively understand the candidate value corresponding to an object O31 simply by glancing at that object O31.

A single object O31 is selected in the candidate value list area A33. The currently-selected object O31 (called a “selected object O31s” hereinafter) and the other objects O31 (called “non-selected objects O31n” hereinafter) are displayed in the candidate value list area A33 using different color tones. Immediately after transitioning from the shooting standby screen S11 to the quick settings menu screen S15, the selected object O31s indicates the current value of the customized item corresponding to the selected object O23.

As shown in FIG. 18C, the user can select one of the non-selected objects O31n in the candidate value list area A33 by making a predetermined operation through the touch panel 125. When one of the non-selected objects O31n is selected by the user, the non-selected object O31n and the selected object O31s are interchanged. As a result, the current value of the customized item that corresponds to the selected object O23 is changed to the candidate value that corresponds to the new selected object O31s. The controller 130 registers the changed current value of the customized item corresponding to the selected object O23 in the current value holding region 142b.

Then, as shown in FIGS. 18C and 18D, when the user selects a “return” icon Is in the quick settings menu screen S15 through the touch panel 125, the digital camera 200 transitions to the shooting standby screen S11.

### 3. Variations

The techniques disclosed here are not intended to be limited to the aforementioned embodiments, and various other embodiments thereof are conceivable as well. The following are examples thereof.

(3-1)

The aforementioned embodiments give examples of cases in which customized items are selected from among settings items regarding shooting conditions. However, the present invention is not limited to such an example. For example, the present invention can also be applied in the case in which customized items are selected from among settings items regarding reproducing conditions. Alternatively, the present invention can be applied in the case in which customized items are selected from among settings items regarding both shooting conditions and reproducing conditions. In such a case, both a quick settings menu screen and a quick customize screen may be prepared for each of the shooting conditions and the reproducing conditions. As a result, the user can select a predetermined number of customized items for each of the shooting conditions and the reproducing conditions. It should be noted that it is preferable to be able to transition to the quick settings menu screen and the quick customize screen for the reproducing conditions from a screen displayed during the reproduction mode.

(3-2)

The present invention can be applied not only in imaging devices but also in other electronic devices that have multiple settings items.

(3-3)

In the second embodiment, the center button 204, the directional button 205, and the Q menu button 208 have been omitted. However, the digital camera 200 may be provided with the center button 204, the directional button 205, and the Q menu button 208. In such a case, operations made through the touch panel 125 in the second embodiment may be replaced with operations made using the center button 204, the directional button 205, and the Q menu button 208.

(3-4)

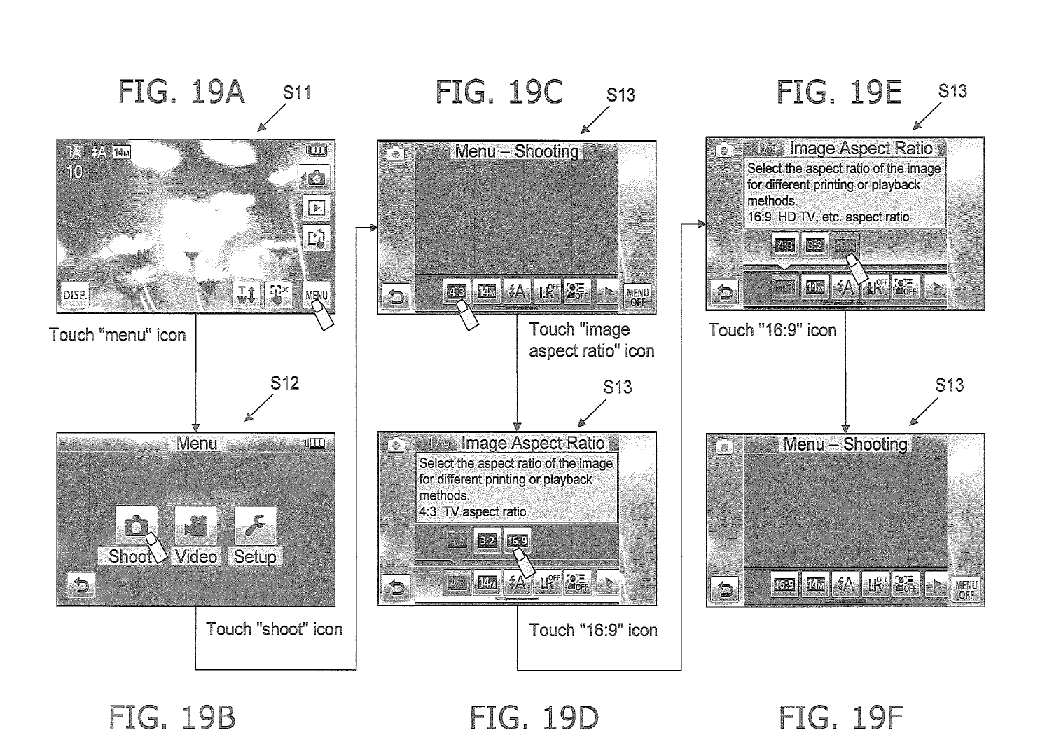

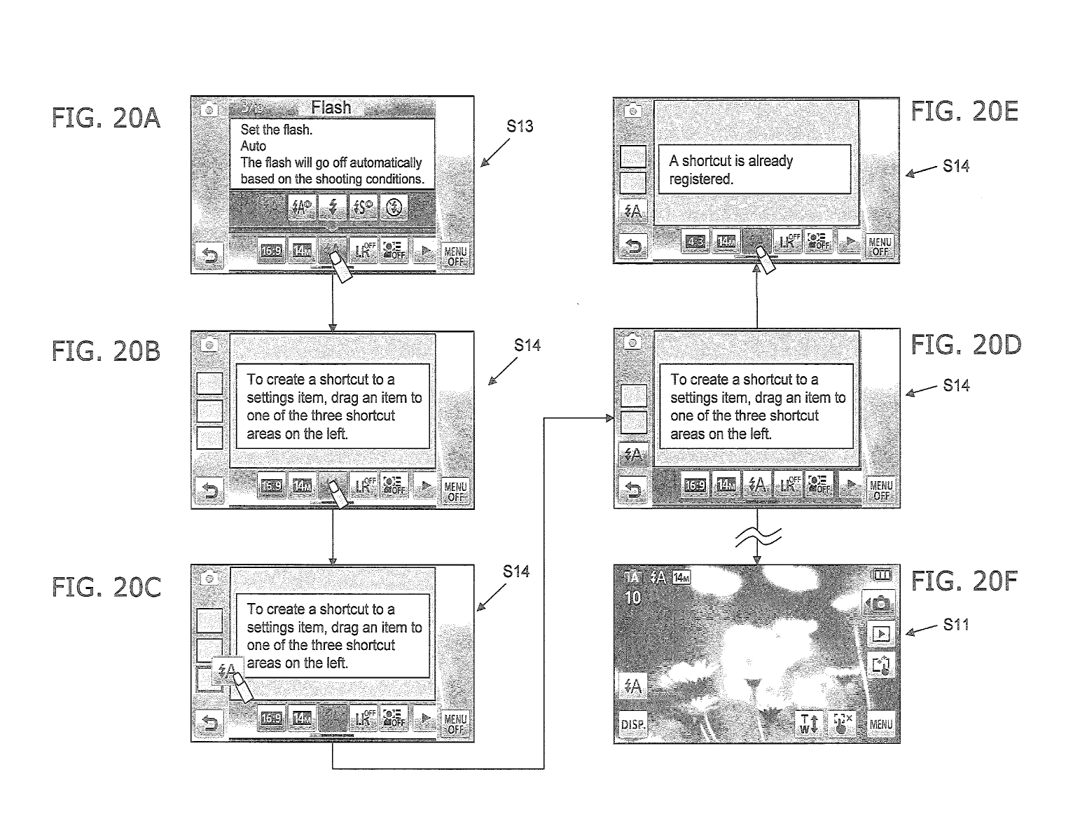

The screens illustrated in FIGS. 15 and 16, displayed by the digital camera 200 according to the second embodiment, can be changed to configurations such as those illustrated in FIGS. 19 and 20 respectively. In other words, the “customize” icon Id can be omitted from the settings menu screen S13.

Then, the quick customize screen S14 may be transitioned to when an object O11 in the settings item list area A12 is selected in a predetermined manner (for example, is pressed and held down for a predetermined amount of time). Alternatively, a customized item may be newly registered by an object O11 within the settings item list area A12 being dragged and dropped into the customized item area A21. In other words, the settings menu screen S13 may play the role of the quick customize screen S14.

Furthermore, in the display, the object O21 as a whole, rather than only an outer frame of the object O21, may move.

(3-5)

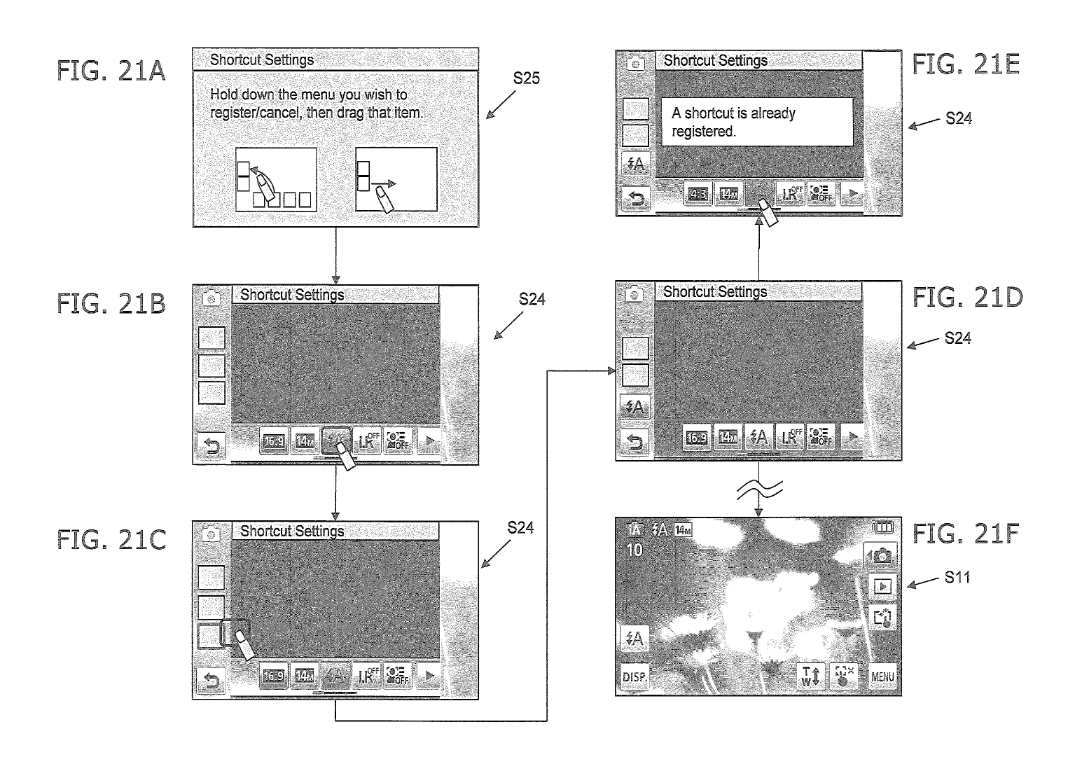

The screen illustrated in FIG. 16, displayed by the digital camera 200 according to the second embodiment, can be changed to a configuration such as that illustrated in FIG. 21. In other words, the digital camera 200 transitions to the message screen S25 shown in FIG. 21A when the user selects the “customize” icon Id in the settings menu screen S13 through the touch panel 125. The message screen S25 is a screen in which the message area A23 shown in FIG. 16A has been enlarged to fill the entire liquid crystal monitor 123. As a result, in the present variation, the space to display messages is greater than in the second embodiment.

The controller 130 displays the message screen S25 in the liquid crystal monitor 123 for a predetermined amount of time (for example, five seconds), and then displays the quick customize screen S24 illustrated in FIG. 21B. Note that the message screen S25 may be set to disappear after a predetermined operation has been made, rather than automatically.

The quick customize screen S24 is a screen in which the message window A23 has been omitted from the quick customize screen S14 of the second embodiment. The quick customize screen S24 displays a through-the-lens image instead of the message window A23. However, the through-the-lens image in the quick customize screen S24 has a lower degree of transparency than the through-the-lens image in the shooting standby screen S11. When the user depresses the release button 201 or 206 in a state in which the quick customize screen S24 is being displayed in the liquid crystal monitor 123, the controller 130 controls the various elements of the digital camera 200 so as to cause the recording of a still image or a moving picture.

The digital camera 200 according to the present variation is capable of allowing the shooting of a still image or a moving picture even if the quick customize screen S24 is being displayed.

Likewise, the digital camera 200 may be capable of allowing the shooting of a still image or a moving picture even if the settings menu screen S13 is being displayed. Furthermore, the digital camera 200 may be capable of allowing the shooting of a still image or a moving picture even if the quick settings menu screen S15 is being displayed. The settings menu screen S13 and the quick settings menu screen S15 are screens in which a through-the-lens image is displayed.

### 4

The digital camera 100 is an example of an electronic device, and is also an example of an imaging device. The liquid crystal monitor 123 is an example of a display unit. The touch panel 125 is an example of an operation unit. The controller 130 is an example of a registration unit. The flash memory 142 is an example of a storage unit. The operation unit 150 is an example of an operation unit. The settings menu screen S1 is an example of a settings screen. The quick settings menu screen S4 is an example of a customized settings screen. The quick customize screen S6 is an example of a customized screen. The settings menu screen S13 is an example of a settings screen. The quick customize screen S14 is an example of a customized screen. The quick settings menu screen S15 is an example of a customized settings screen.

According to the technique disclosed herein, an electronic device that enables user-friendly operations for selecting one or more customized items from among multiple settings items can be provided.

### General Interpretation of Terms

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

The term “configured” as used herein to describe a component, section, or part of a device implies the existence of other unclaimed or unmentioned components, sections, members or parts of the device to carry out a desired function.

The terms of degree such as “substantially” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. An electronic device comprising:
a display unit configured to display a customized screen, the customized screen being configured to display a settings item area and a customized item area, the setting item area being configured to include a plurality of objects that corresponds to a plurality of settings items, and the customized item area being configured to include one or more objects that corresponds to one or more customized items selected by a user from among the plurality of settings items; and
an operation unit configured to receive a customization operation from the user in which an object is selected from among the plurality of objects disposed in the settings item area and moved to the customized item area while the customized screen is being displayed in the display unit.

2. The electronic device according to claim 1, wherein
at least one of the objects disposed in the customized item area has an appearance indicating a current value of the customized item.

3. The electronic device according to claim 1, wherein
at least one of the objects disposed in the settings item area has an appearance indicating a current value of the settings item.

4. The electronic device according to claim 1, further comprising:
a storage unit configured to store information about the one or more customized items; and
a registration unit configured to store information in the storage unit about one of the settings items, the stored information about one of the settings items corresponding to the object moved to the customized item area via the customization operation and being stored in the storage unit as information about one of the customized items.

5. The electronic device according to claim 1, wherein
the display unit is further configured to display a customized settings screen configured to receive a setting for current values of the one or more customized items.

6. The electronic device according to claim 1, wherein
the display unit is further configured to display a settings screen configured to receive settings for current values of the plurality of settings items.

7. The electronic device according to claim 1, wherein
the operation unit includes a touch panel arranged to overlap the display unit, and
the customization operation includes an operation to drag and drop the object disposed in the settings item area to the customized item area.

8. The electronic device according to claim 1, wherein
the electronic device is an imaging device.

9. The electronic device according to claim 8, wherein
the one or more customized items relate to at least one of shooting conditions and reproduction conditions.
